(19) United States
(12) Patent Application Publication
(10) Pub. No.: US 2011/0050758 A1
(43) Pub. Date: Mar. 3, 2011

(54) Display Driving Device and method thereof

(76) Inventors: Yue-Li Chao, Taoyuan County (TW); Shih-Chieh Yen, Chiayi County (TW)

(21) Appl. No.: 12/642,868

(22) Filed: Dec. 21, 2009

(30) Foreign Application Priority Data
Sep. 1, 2009 (TW) 098129356

(51) Int. Cl. G09G 5/02

(52) U.S. Cl. 345/694; 345/698

(57) ABSTRACT

In a display system, sums of differences between two consecutive frames are calculated according to differences, which are able to indicate a degree of difference between frames, such as pixel differences or luminance differences. A motion proportion is calculated according to various values of sums of differences of different blocks between frames, so that the degree of difference between the two consecutive frames may be indicated more concretely. At last, according to settings of a lookup table, different motion proportions may respectively correspond to different frame rates and different displaying states for displaying a frame under different requirements, so that the aim of saving power consumption without reducing display quality of frames is fulfilled.

### BACKGROUND OF THE INVENTION

1. Field of the Invention

The present invention relates to a display driving device and method thereof, and more particularly, to a display driving device for reducing power consumption and method thereof.

2. Description of the Prior Art

A conventional liquid crystal display displays a large amount of frames within a short time for displaying motion pictures, so that an observer may perceive motions of objects on the displayed motion pictures by taking advantages of persistence of vision. A frame rate indicates an amount of frames displayed unit time, and has a unit as frames per second (FPS) or Hertz (Hz). Conventionally, while the frame rate is higher than 16 frames per second, the observer may perceive that a certain object on the motion pictures is continuously-displayed, instead of discretely-displayed, because of the effect of persistence of vision. A conventional motion picture movie is also rapidly displayed using the same principle. While the frame rate reaches 24 frames per second, objects on displayed motion pictures perceived by naked eyes are displayed smoothly enough; however, for some applications or games, which requires high dynamic visual acuity, a higher frame rate is required since a single frame of the applications or games merely includes visual information at an instant moment.

A frame rate, which may also be referred as a frame data updating rate, of a conventional liquid crystal display is always constant. Power consumption of a driving circuit for driving a display panel within the liquid crystal display in displaying frames is also proportional to the frame rate. In other words, the power consumption is also constant for the driving circuit in displaying the frames.

### SUMMARY OF THE INVENTION

The claimed invention discloses a display driving method and a display system, for reducing power consumption and improving display quality.

The claimed invention discloses a display driving method. The method comprises respectively segmenting a first frame and a second frame into a plurality of first blocks and a plurality of second blocks according to a resolution; calculating a sum of differences between a pair of first and second blocks; calculating a motion proportion according to all sums of differences between the first frame and the second frame, and according to a plurality of weights for sum of differences; and determining a frame rate and whether a frame is displayed according to the motion proportion. The pair of first and second blocks has a same size. The second frame is displayed right after the first frame is displayed, and each of the plurality of first blocks has a corresponding block within the plurality of second blocks to form a pair.

The claimed invention discloses a display system. The display system comprises a block segmenting module, a sum of difference calculating module, a motion proportion calculating module, and a frame modulation module. The block segmenting module is for respectively receiving a first frame and a second frame, and for respectively segmenting the first and second frames into a plurality of first blocks and a plurality of second blocks according to a resolution. The second frame is displayed right after the first frame is displayed. Each of the plurality of first blocks has a corresponding block within the plurality of second blocks to form a pair. The sum of difference calculating module is for calculating a sum of differences between a pair of first and second blocks. The motion proportion calculating module is for calculating a motion proportion according to all sums of differences between the first frame and the second frame, and according to a plurality of weights for sum of differences. The frame modulation module is for determining a frame rate and whether a frame is displayed according to the motion proportion. The pair of first and second blocks has a same size.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 6 are block diagrams of a display system according to embodiments of the present invention.

FIG. 2 schematically illustrates how the frames are segmented into a plurality of first and second blocks according to a resolution.

FIG. 3, FIG. 4, and FIG. 5 are diagrams of the lookup table established inside a frame modulation module according to embodiments of the present invention.

FIG. 7 is a flowchart of the method of reducing power consumption without reducing display quality of a display system according to an embodiment of the present invention.

### DETAILED DESCRIPTION

The present invention discloses a display driving method and a display system thereof for reducing power consumption of the display system without reducing display quality, for example, without introducing flickers. In the present invention, two consecutively-received frames are respectively segmented into a plurality of image blocks having different sizes; a sum of difference between the two consecutive frames is calculated in units of image blocks; a motion proportion between the two consecutive frames is calculated according to calculated sums of difference on both the frames; a frame rate for displaying a related frame and whether the related frame is displayed are determined according to the motion proportion, for preventing displaying frames, which have an over-high frame rate or introduce flickers; and as a result, the aim of reducing power consumption without reducing display quality is achieved.

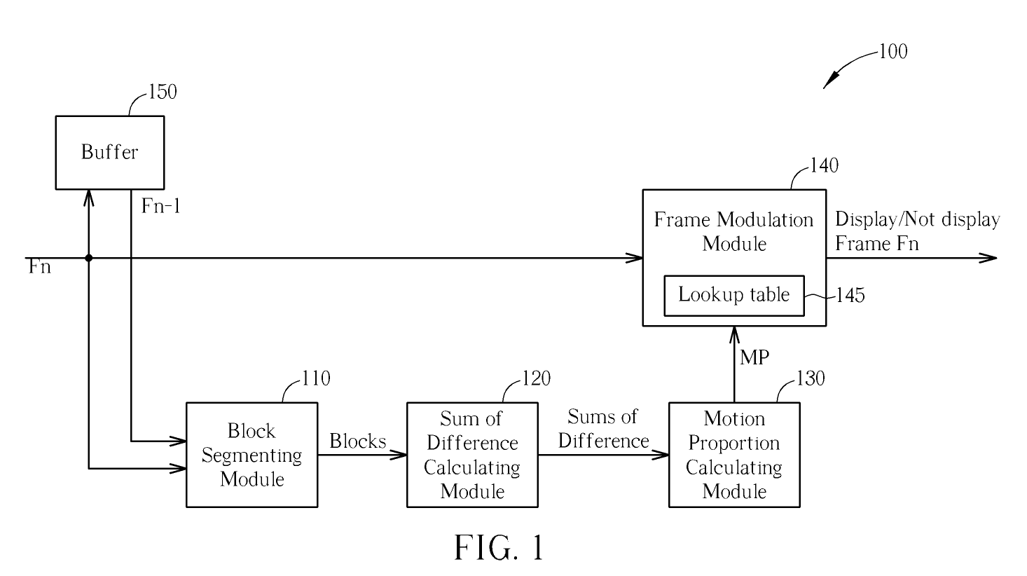

Please refer to FIG. 1, which is a block diagram of a display system 100 disclosed in the present invention. As shown in FIG. 1, the display system 100 includes a block segmenting module 110, a sum of difference calculating module 120, a motion proportion calculating module 130, a frame modulation module 140, and a buffer 150.

The display system 100 receives two consecutively-displayed frames Fn−1 and Fn, where the frame Fn−1 is received and displayed earlier than the frame Fn. The buffer 150 is used for buffering the frame Fn−1 until the frame Fn is received by the display system 100. Right after the frame Fn is received by the display system 100, the frame Fn is also buffered by the buffer 150.

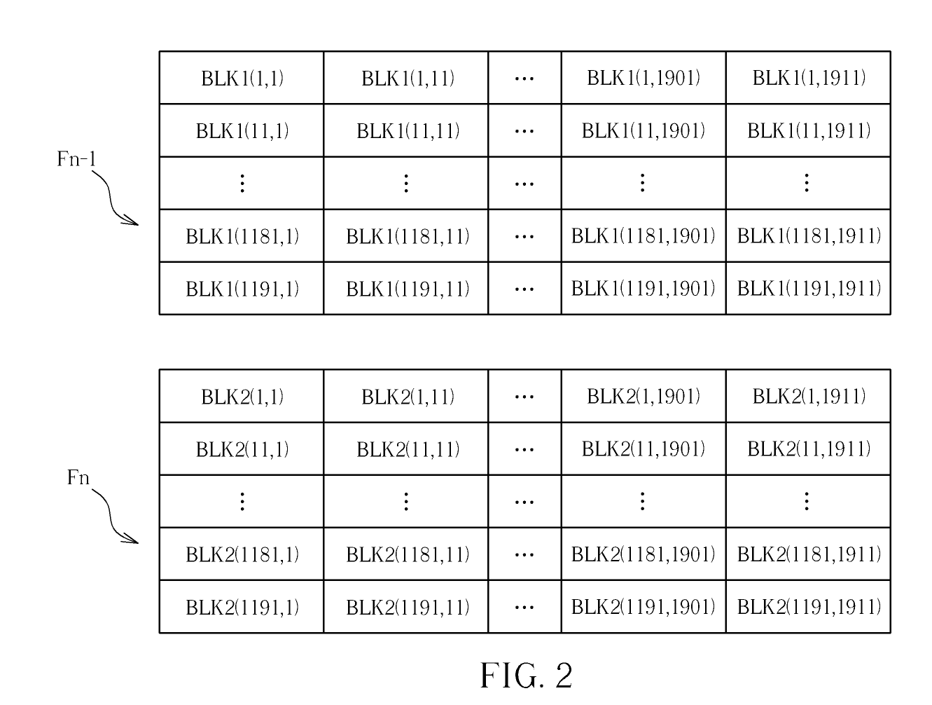

The block segmenting module 110 segments the frame Fn−1 into a plurality of first blocks, and segments the frame Fn into a plurality of second blocks, according to a resolution, where each of the plurality of first blocks has a corresponding block within the plurality of second blocks to form a pair. Please refer to FIG. 2, which schematically illustrates how the frame Fn−1 is segmented into a plurality of first blocks BLK1 (1,1), BLK1 (1,11), . . . , BLK1 (1191,1911) and how the frame Fn is segmented into a plurality of second blocks BLK2 (1,1), BLK2 (1,11), . . . , BLK2 (1191,1911), according to a resolution. In FIG. 2, both the frames Fn−1 and Fn are supposed to include 1200*1920 pixels, and moreover, while the resolution is set to 120*192, a single first block or a single second block is supposed to include 10*10 pixels in size. Therefore, in FIG. 2, the frame Fn−1 is supposed to be segmented into 120*192 first blocks BLK1 (1,1), BLK1 (1,11), . . . , BLK1 (1191,1911), and the frame Fn is supposed to be segmented into 120*192 blocks BLK2 (1,1), BLK2 (1,11), . . . , BLK2 (1191,1911), so that the frames Fn−1 and Fn may be regarded as two block matrices having the size 120*192. Each of the first or second blocks includes 10*10 pixels, and a coordinate shown in each of the first or second blocks indicates a coordinate of a pixel at a northwest corner of each the block on a corresponding frame. For example, a pixel at a northwest corner of the first block BLK1 (11,1901) occupies a coordinate (11,1901) on the frame Fn−1. Note that in other embodiments of the present invention, the amount of pixels on a single frame and the resolution are not restricted by the above embodiments, and moreover, a plurality of blocks segmented from a same frame do not have to be the same in size, as long as each frame is segmented into blocks of a same combination of sizes. For example, in an embodiment of the present invention, the first block BLK1 (1,1) has to be the same with the second block BLK2 (1,1) in size and scale, i.e., in length and width, whereas the first block BLK1 (1,1) may be different from the first block BLK1 (1,11) or the second block BLK2 (1,11) in size and scale, and the first block BLK1 (1,11) and the second block BLK2 (1,11) must be the same in size and scale.

The sum of difference calculating module 120 calculates a sum of difference (SOD) between a pair of first and second blocks segmented by the block segmenting module 110. For example, in FIG. 2, the sum of difference calculating module 120 is capable of calculating a plurality of differences between the blocks BLK1 (1, 1) and BLK2 (1,1), between the blocks BLK1 (1,11) and BLK2 (1,11), . . . , between the blocks BLK1 (1191, 1901) and BLK2 (1191,1901), and between the blocks BLK1 (1191,1911) and BLK2 (1191,1911); the sum of difference calculating module 120 then sums the plurality of calculated differences to generate a sum, and dividing the sum by a total number of blocks on the frame Fn−1 or Fn, i.e., by 120*192, to generate a sum of difference. Note that in a first embodiment of the present invention, a difference between a pair of first block BLK1 and second block BLK2 may be a pixel difference or a luminance difference, where the luminance difference may be retrieved according to:

Y=kr*R+kg*G+kb*B (1);

Y indicates the luminance difference. R, G, and B respectively indicate a red pixel value, a green pixel value, and a blue pixel value of the pixel difference. kr, kg, and kb are all constants. The equation (1) indicates a conventional way in transforming pixel values into luminance values so that said equation (1) is not further introduced herein. The pixel difference between the first and second blocks BLK1 and BLK2 may be a first sum of differences between pixels the first and second blocks BLK1 and BLK2, or may be a second sum, which is retrieved by normalizing the first sum; however, calculating the pixel difference between the blocks BLK1 and BLK2 are not restricted by the above examples. Similarly, the luminance difference between the first and second blocks BLK1 and BLK2 may be a third sum of differences in luminance between pixels of the first and second blocks BLK1 and BLK2, or may be a fourth sum, which is retrieved by normalizing the third sum, or may be other forms of luminance difference between the blocks BLK1 and BLK2. Therefore, the calculated sum of differences may be a sum of pixel difference or a sum of luminance difference.

Concretely speaking, a sum of difference calculated by the sum of difference calculating module 120 may be indicated as follows:

$$FA\_SOD ( m , n ) = {\sum }_{m = 1}^{M} {\sum }_{n = 1}^{N} \vert FA\_P ( m , n ) - FB\_P ( m , n ) \vert ; \qquad ( 2 )$$

M and N respectively indicate a length and a width of a block matrix on a single frame, for example, while a frame includes 120*192 blocks, M should be 120, and N should be 192. (m,n) indicates both coordinates of a first reference pixel on the first block BLK1 and a second reference pixel on the second block BLK2; for example, the first reference pixel may be a pixel at the northwest corner of the block BLK1 (11,1901), and the second reference pixel may be a pixel at the northwest corner of the block BLK2 (11,1901), i.e., the pixel at the coordinate (11,1901) on both the frames Fn−1 and Fn, where m should be 11, and n should be 1901. FA_SOD(m,n) indicates the sum of differences, and as mentioned above, FA_SOD(m,n) may be a sum of pixel differences or a sum of luminance difference. FA_P(m,n) indicates a representative difference of the first block BLK1, which may be a representative pixel difference or a representative luminance difference of the first block BLK1. Similarly, FB_P(m,n) indicates a representative difference of the second block BLK2, which may be a representative pixel difference or a representative luminance difference of the second block BLK2. After the sum of difference calculating module 120 processes all blocks on the frames Fn−1 and Fn, there will be a sum of differences for each block on either one of the frames Fn−1 and Fn, i.e., FA_SOD(m,n).

In an embodiment of the present invention, the sum of difference calculating module 120 further fetches a plurality of most significant bits (MSB) on each sum of differences to normalize each the sum of differences, so as to generate a plurality of normalized sums of difference. For example, under an assumption that a pixel value ranges from 1 to 255, the sum of difference calculating module 120 fetches two most significant bits from the pixel values 36, 95, 172, and 232, which are indicated as “00100100”, “01011111”, “10101100”, and “11101000” in respective binary forms, to generate binary normalized sums of difference “00”, “01”, “10”, and “11”; it indicates the fact that the pixel values are normalized to be normalized sums of difference 0, 1, 2, 3 so that the pixels values can be classified, and as a result, the motion proportion calculating module 130 may process according to the normalized sums of difference.

The motion proportion calculating module 130 calculates a motion proportion MP according to all sums of difference between the frames Fn−1 and Fn, and according to a plurality of weights of sum of difference. The motion proportion MP provides a more concrete indication on a degree of difference between the frames Fn−1 and Fn in pixel values or in luminance. That is, a higher motion proportion MP indicates a larger difference between the frames Fn−1 and Fn. In an embodiment of the present invention, the motion proportion calculating module 130 multiplies each of the normalized sums of difference between the frames Fn−1 and Fn with one of the plurality of weights for sum of differences according to different values of the sums of pixel difference, for generating a total weighted sum of pixel difference, where the normalized sums of difference between the frames Fn−1 and Fn are generated by the sum of difference calculating module 120. At last, the motion proportion calculating module 130 fetches a plurality of most significant bits from the total weighted sum of difference to generate the required motion proportion MP. By following the example mentioned above and related to normalization of the sum of difference calculating module 120, the motion proportion calculating module 130 may multiply an amount of blocks having a normalized sum of difference equal to 0 with both the normalized sum of difference 0 and a weight 0, may multiply a number of blocks having a normalized sum of difference equal to 1 with both the normalized sum of difference 1 and a weight 1, may multiply a number of blocks having a normalized sum of difference equal to 2 with both the normalized sum of difference 2 and a weight 4, and may multiply a number of blocks having a normalized sum of difference equal to 3 with both the normalized sum of difference 3 and a weight 8, to generate four weighted sums of difference. Then the motion proportion calculating module 130 sums the four weighted sum of difference to generate a total weighted sum of difference. At last, the motion proportion calculating module 130 fetches two most significant bits from the total weighted sum of difference to generate the motion proportion MP, which may be “00”, “01”, “10”, “11” in binary form or be 0, 1, 2, 3 in decimal form. Taking a more concrete example, assume that the sum of difference calculating module 120 calculates a result, which indicates that there are 12*192 blocks having a normalized sum of difference 0, 36*192 blocks having a normalized sum of difference 1, 64*192 blocks having a normalized sum of difference 2, and 8*192 blocks having a normalized sum of difference 3 in the 120*192 blocks on a single frame, the total weighted sum of difference should be 0*(12*192)*1+1*(36*192)*2+2*(64*192)*4+3*(8*192)*8=148992; since two most significant bits of the total weighted sum of difference 148992 are “10”, the motion proportion calculating module 130 will determine the motion proportion MP to be “10” in binary form or 3 in decimal form.

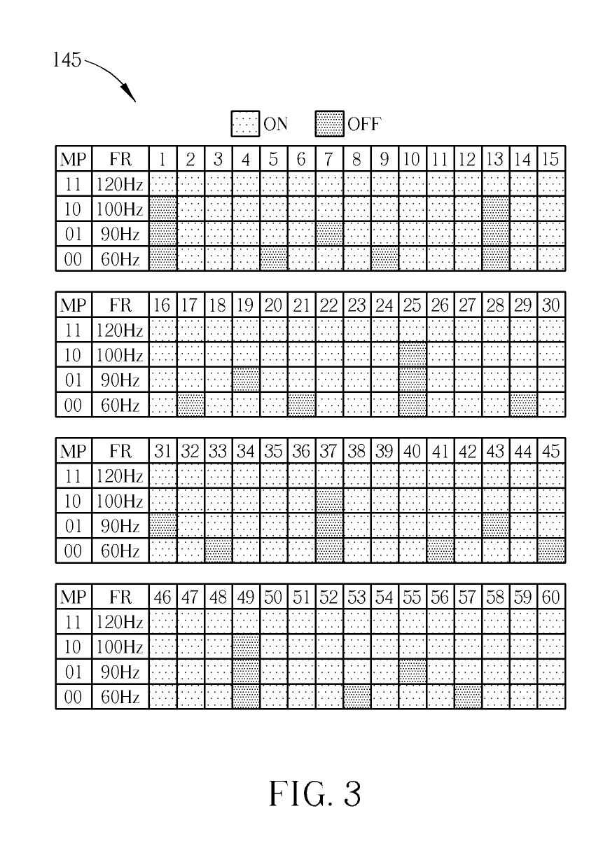

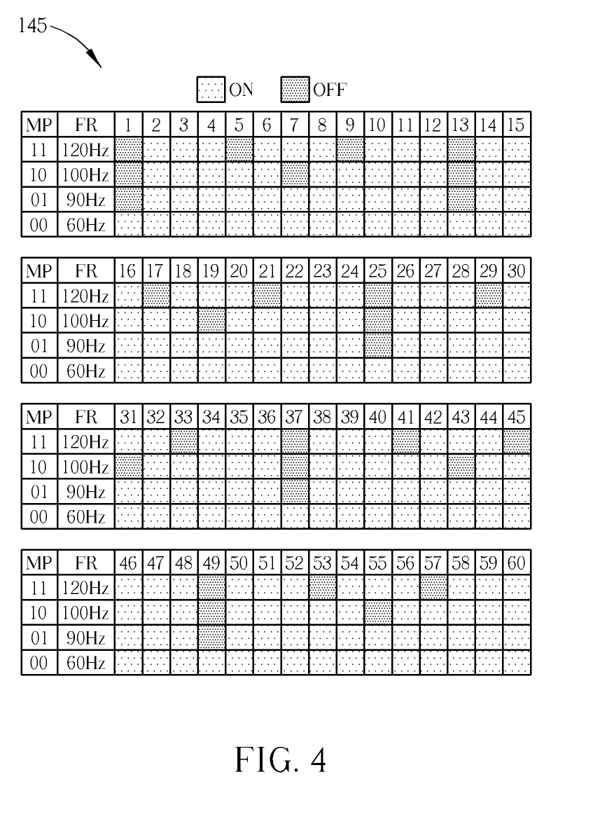

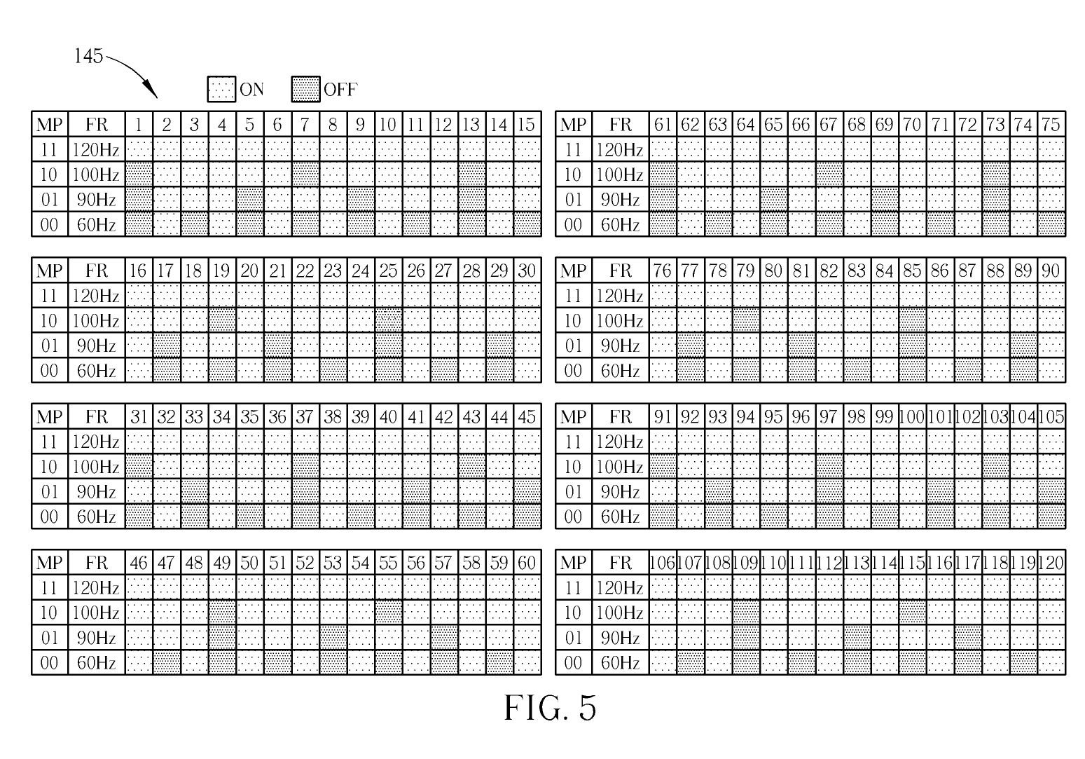

The frame modulation module 140 determines a frame rate FR for displaying the frame Fn or whether the frame Fn is displayed according to the motion proportion MP calculated by the motion proportion calculating module 130. The frame modulation module 140 establishes a lookup table 145, which serves as a basis in determining the frame rate FR and whether the frame FR is displayed. Please refer to FIG. 3, which is a diagram of the lookup table 145 established inside the frame modulation module 140 shown in FIG. 1 according to an embodiment of the present invention, where the lookup table 145 includes non-index fields corresponding to various values of the frame rate FR or the motion proportion MP and corresponding to whether the sixty consecutive frames having serials from 1 to 60 are displayed. As shown in FIG. 3, an index of the lookup table 145 is the motion proportion MP calculated by the motion proportion calculating module 130, where values of the frame rate FR corresponding to different values of the motion proportion MP. For example, in FIG. 3, while the value of the motion proportion MP received by the frame modulation module 140 is “10”, the frame rate FR is determined to be 55 Hz by querying the lookup table 145, where the motion proportion MP is used as an index; moreover, whether each of the sixty consecutive frames is displayed is determined according to both the frame rate FR and the motion proportion MP as well. Note that the filled fields of the lookup table 145 shown in FIG. 3 indicate actions of not displaying the frame Fn, whereas the unfilled fields of the lookup table 145 indicate actions of displaying the frame Fn.

As can be observed from FIG. 3, a larger motion proportion MP brings a higher frame rate FR, whereas a smaller motion proportion MP brings a lower frame rate FR as well, under an assumption that the lookup table 145 is designed for a better resolution of the displayed frame. Further, since a higher motion proportion MP indicates a larger difference between the frames Fn−1 and Fn in pixel values or luminance values, a shorter motion picture response time (MPRT) is required in displaying the frame Fn; in other words, the frame Fn cannot be displayed with an over-low frame rate FR, or edge blurs are brought to reduce a definition of displaying the frame Fn. On the contrary, while the motion proportion MP is lower, a lower frame rate FR will not bring the edge blurs, so that certain fields in the lookup table 145 shown in FIG. 3 indicate using a lower frame rate FR to display the frame, and power consumption is reduced as a result of using the lower frame rate FR.

Besides, in the lookup table 145 shown in FIG. 3, while the motion proportion MP is lower, the frame Fn is determined not to be displayed by following a certain regulation and recursion, i.e., the non-index and filled fields in the lookup table 145 shown in FIG. 3. Therefore, the frame Fn is normally displayed under a higher motion proportion MP and a higher frame rate FR, and is not displayed under a lower motion proportion MP and a lower frame rate FR, so that the purpose of reducing power consumption is fulfilled as a result. For example, in FIG. 3, display states of five sets including frames 1-12, 13-24, 25-36, 37-48, and 49-60 are following a same pattern, i.e., the frame modulation 140 controls whether the frame is displayed using a periodical and recursive pattern. However, the periodical and recursive pattern illustrated in FIG. 3 is used according to an embodiment of the present invention, and embodiments formed by changing the pattern shown in FIG. 3 in a recursive or periodical manner should also be regarded as embodiments of the present invention.

Please refer to FIG. 4, which also illustrates the lookup table 145 established inside the frame modulation module 140 shown in FIG. 1 according to another embodiment of the present invention, where conditions in setting filled/unfilled fields are different from the conditions used in FIG. 3. In FIG. 4, since a higher frame rate FR is used under a higher motion proportion MP, flickers are not easily observed by naked eyes of an observer. On the contrary, while a lower frame rate FR is used under a smaller motion proportion MP, flickers will be easily observed by the naked eyes. In the lookup table 145 shown in FIG. 4, frames corresponding to higher motion proportions MP and higher frame rates FR are not displayed periodically and recursively for reducing power consumption. On the contrary, for relieving flickers under lower motion proportions MP as much as possible for preventing from reducing displaying qualities, frames corresponding to lower motion proportions MP are also prevented from not being displayed so as to reduce flickers.

The lookup table 145 shown in FIG. 3 and FIG. 4 are described under a basic frame rate equal to 60 Hz, however, setting for the lookup table 145 may also be used for display systems having a basic frame rate equal to 120 Hz. Please refer to FIG. 5, which schematically illustrates applying the lookup table 145 shown in FIG. 1 on a display system having a basic frame rate 120 Hz. A setting principle for the lookup table 145 shown in FIG. 5 is the same with the setting principle used in FIG. 3 so that said setting principle is not further described. Since the lookup table 145 shown in FIG. 5 is under a higher basic frame rate than the basic frame rate in FIG. 3, for achieving reducing power consumption, there are more unfilled fields in the lookup table 145 shown in FIG. 5, i.e., there are more un-displayed frames. Besides, in a preferred embodiment of the present invention, a display system 100 corresponding to the lookup table 145 shown in FIG. 5 calculates the motion proportion MP according to luminance differences.

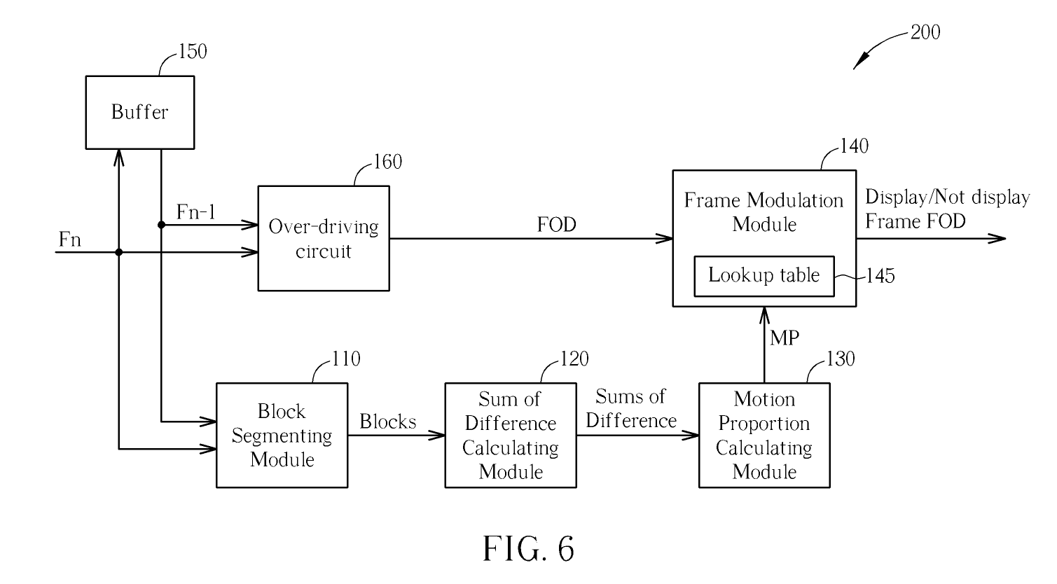

Besides determining the frame rate FR and whether the frame Fn is displayed by using the display system 100 shown in FIG. 1, in another embodiment of the present invention, overdriving is used in displaying frames for further reducing the motion picture response time. Please refer to FIG. 6, which is a diagram of a display system 200 according to another embodiment of the present invention. As shown in FIG. 6, besides all elements of the display system 100 shown in FIG. 1, the display system 200 further includes an overdriving circuit 160. The overdriving circuit 160 is used for receiving the frame Fn and the frame Fn−1, which is previously buffered by the buffer 150, for generating an overdriving frame FOD. Operations of the block segmenting module 110, the sum of difference calculating module 120, and the motion proportion calculating module 130 are the same as mentioned above. The frame modulation module 140 receives the overdriving frame FOD in the display system 200, instead of the frame Fn shown in FIG. 1. The frame modulation module 140 determines a frame rate FR for displaying the overdriving frame FOD and whether the overdriving frame FOD is displayed according to the motion proportion MP calculated by the motion proportion calculating module 130, where the manner of determining the frame rate FR and whether the overdriving frame FOD is displayed are the same as those described related to FIG. 3, FIG. 4, and FIG. 5.

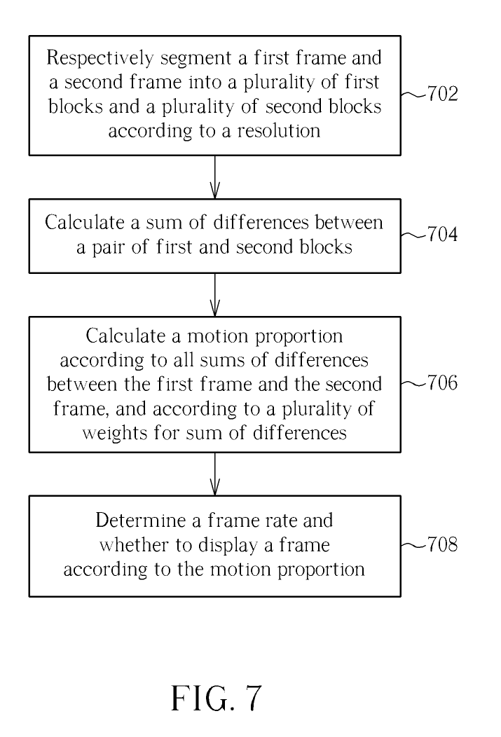

Please refer to FIG. 7, which is a flowchart of the method of reducing power consumption without reducing display quality of a display system according to an embodiment of the present invention. As shown in FIG. 7, the method includes steps as follows:

Step 702: Respectively segment a first frame and a second frame into a plurality of first blocks and a plurality of second blocks according to a resolution;

Step 704: Calculate a sum of differences between a pair of first and second blocks;

Step 706: Calculating a motion proportion according to all sums of differences between the first frame and the second frame, and according to a plurality of weights for sum of differences; and

Step 708: Determine a frame rate and whether a frame is displayed according to the motion proportion.

The steps form a summary about the above descriptions from FIG. 1 to FIG. 6. However, other embodiments formed by adding abovementioned restrictions on the flowchart shown in FIG. 7 or by reasonably permuting or combining steps shown in FIG. 7 should also be regarded as embodiment of the present invention.

The present invention discloses a method of reducing power consumption without reducing displaying quality of a display system and the display system thereof. In the present invention, a sum of difference between two consecutively-displayed frames is calculated according to practical frame differences, which may include pixel differences or luminance differences. A motion proportion is generated by weighting sums of difference of various blocks in both the frames according to different values of the sums of difference, for concretely indicating the difference between the consecutive frames. At last, by setting a lookup table, different values of the motion proportion may be corresponding to different values of frame rates and different displaying states under different requirements, so that the aim of reducing power consumption without reducing the displaying quality is fulfilled.

Those skilled in the art will readily observe that numerous modifications and alterations of the device and method may be made while retaining the teachings of the invention.

What is claimed is:

1. A display driving method, comprising:
respectively segmenting a first frame and a second frame into a plurality of first blocks and a plurality of second blocks according to a resolution, wherein the second frame is displayed right after the first frame is displayed, and each of the plurality of first blocks has a corresponding block within the plurality of second blocks to form a pair;
calculating a sum of differences between a pair of first and second blocks;
calculating a motion proportion according to all sums of differences between the first frame and the second frame, and according to a plurality of weights for sum of differences; and
determining a frame rate and whether a frame is displayed according to the motion proportion;
wherein the pair of first and second blocks have a same size.

2. The display driving method of claim 1, wherein sizes of the plurality of first blocks are not all the same, and sizes of the plurality of second blocks are not all the same.

3. The display driving method of claim 1, wherein sizes of the plurality of first blocks are all the same, and sizes of the plurality of second blocks are all the same.

4. The display driving method of claim 1,
wherein calculating the sum of differences between the pair of first and second blocks comprises:
calculating a sum of pixel differences between the pair of first and second blocks;
wherein calculating the motion proportion according to all sums of differences between the first frame and the second frame and according to the plurality of weights for sum of differences comprises:
calculating the motion proportion according to all sums of pixel differences between the first frame and the second frame and according to a plurality of weights for sum of pixel differences.

5. The display driving method of claim 4,
wherein calculating the sum of pixel differences between the pair of first and second blocks comprises:
calculating the sum of pixel differences according to the following equation:
$$FA\_SOD ( m , n ) = {\sum }_{m = 1}^{M} {\sum }_{n = 1}^{N} \vert FA\_P ( m , n ) - FB\_P ( m , n ) \vert ;$$
wherein each of the first and second blocks respectively comprises a same amount of pixels, which are arranged as a matrix; each pixel of the first block has a corresponding pixel within the second block to form a pair; and M and N respectively indicate a length and a width of the matrix;
wherein FA_SOD(m,n) indicates the sum of pixel differences, (m,n) indicates a coordinate occupied by both a first reference pixel on the first block and a second reference pixel on the second block, FA_P(m,n) indicates a representative pixel value on the first block, and FB_P(m,n) indicates a representative pixel value on the second block.

6. The display driving method of claim 5, further comprising:
fetching a plurality of most significant bits from the sum of pixel differences so as to generate a normalized sum of pixel differences.

7. The display driving method of claim 4,
wherein calculating the motion proportion according to all sums of pixel differences between the first frame and the second frame and according to the plurality of weights for sum of pixel differences comprises:
multiplying each of the sums of pixel difference between the first and second frames with one of the plurality of weights for sum of pixel differences according to different values of the sums of pixel difference between the first and second frames, for generating a plurality of weighted sums of pixel difference; and
summing the generated plurality of weighted sums of pixel difference to generate a total weighted sum of difference, and dividing the total weighted sum of difference by an amount, which is indicated as a number of pixels on the first frame or the second frame, for generating the motion proportion;
wherein the plurality of weights for sum of pixel differences are corresponding to different values of the sums of pixel difference.

8. The display driving method of claim 1 further comprising:
transforming a plurality of pixel values of the plurality of pixels of the plurality of first and second bocks into a plurality of luminance values;
wherein calculating the sum of differences between the pair of first and second blocks comprises:
calculating a sum of luminance differences between the pair of first and second blocks;
wherein calculating the motion proportion according to all sums of differences between the first frame and the second frame and according to the plurality of weights for sum of differences comprises:
calculating the motion proportion according to all sums of luminance differences between the first frame and the second frame and according to a plurality of weights for sum of luminance differences.

9. The display driving method of claim 8,
wherein calculating the sum of luminance differences between the pair of first and second blocks comprises:
calculating the sum of luminance differences according to the following equation:
$$FA\_SOD ( m , n ) = {\sum }_{m = 1}^{M} {\sum }_{n = 1}^{N} \vert FA\_P ( m , n ) - FB\_P ( m , n ) \vert ;$$
wherein each of the first and second blocks respectively comprises a same amount of pixels, which are arranged as a matrix; each pixel of the first block has a corresponding pixel within the second block to form a pair; and M and N respectively indicate a length and a width of the matrix;
wherein FA_SOD(m,n) indicates the sum of luminance differences, (m,n) indicates a coordinate occupied by both a first reference pixel on the first block and a second reference pixel on the second block, FA_P(m,n) indicates a representative luminance value on the first block, and FB_P(m,n) indicates a representative luminance value on the second block.

10. The display driving method of claim 9, further comprising:
fetching a plurality of most significant bits from the sum of luminance differences so as to generate a normalized sum of luminance differences.

11. The display driving method of claim 9,
wherein calculating the motion proportion according to all sums of luminance differences between the first frame and the second frame and according to the plurality of weights for sum of luminance differences comprises:
multiplying each of the sums of luminance difference between the first and second frames with one of the plurality of weights for sum of luminance differences according to different values of the sums of luminance difference between the first and second frames, for generating a plurality of weighted sums of luminance difference; and
summing the generated plurality of weighted sums of luminance difference to generate a total weighted sum of difference, and dividing the total weighted sum of difference by an amount, which is indicated as a number of pixels on the first frame or the second frame, for generating the motion proportion;
wherein the plurality of weights for sum of luminance differences are corresponding to different values of the sums of luminance difference.

12. The display driving method of claim 1 further comprising:
establishing a lookup table, which stores both a frame rate corresponding to the motion proportion and a display state of whether the frame is displayed under the frame rate;
wherein determining the frame rate and whether the frame is displayed according to the motion proportion comprises:
querying the lookup table by using the motion proportion as an index, for determining the frame rate and whether the frame is displayed under the determined frame rate.

13. The display driving method of claim 1 further comprising:
performing over-driving on the first frame and the second frame for generating an over-driven frame;
wherein determining the frame rate and whether the frame is displayed according to the motion proportion comprises:
determining a frame rate for displaying the over-driven frame and whether the over-driven frame is displayed, according to the motion proportion.

14. A display system, comprising:
a block segmenting module, for respectively receiving a first frame and a second frame, and for respectively segmenting the first and second frames into a plurality of first blocks and a plurality of second blocks according to a resolution, wherein the second frame is displayed right after the first frame is displayed, and each of the plurality of first blocks has a corresponding block within the plurality of second blocks to form a pair;
a sum of difference calculating module, for calculating a sum of differences between a pair of first and second blocks;
a motion proportion calculating module, for calculating a motion proportion according to all sums of differences between the first frame and the second frame, and according to a plurality of weights for sum of differences; and
a frame modulation module, for determining a frame rate and whether a frame is displayed according to the motion proportion;
wherein the pair of first and second blocks have a same size.

15. The display system of claim 14,
wherein sizes of the plurality of first blocks are not all the same, and sizes of the plurality of second blocks are not all the same.

16. The display system of claim 14,
wherein sizes of the plurality of first blocks are all the same, and sizes of the plurality of second blocks are all the same.

17. The display system of claim 14,
wherein the sum of difference calculating modules calculates a sum of pixel differences between the pair of first and second blocks;
wherein the motion proportion calculating module calculates the motion proportion according to all sums of pixel differences between the first frame and the second frame and according to a plurality of weights for sum of pixel differences.

18. The display system of claim 17,
wherein the sum of pixel differences is calculated according to the following equation:
$$FA\_SOD ( m , n ) = {\sum }_{m = 1}^{M} {\sum }_{n = 1}^{N} \vert FA\_P ( m , n ) - FB\_P ( m , n ) \vert ;$$
wherein each of the first and second blocks respectively comprises a same amount of pixels, which are arranged as a matrix; each pixel of the first block has a corresponding pixel within the second block to form a pair; and M and N respectively indicate a length and a width of the matrix;
wherein FA_SOD(m,n) indicates the sum of pixel differences, (m,n) indicates a coordinate occupied by both a first reference pixel on the first block and a second reference pixel on the second block, FA_P(m,n) indicates a representative pixel value on the first block, and FB_P(m,n) indicates a representative pixel value on the second block.

19. The display system of claim 18,
Wherein the sum of difference calculating module fetches a plurality of most significant bits from the sum of pixel differences, for generating a normalized sum of pixel differences.

20. The display system of claim 17,
wherein the motion proportion calculating module multiplies each of the sums of pixel difference between the first and second frames with one of the plurality of weights for sum of pixel differences according to different values of the sums of pixel difference between the first and second frames, for generating a plurality of weighted sums of pixel difference;
wherein the motion proportion calculating module sums the generated plurality of weighted sums of pixel difference to generate a total weighted sum of difference, and divides the total weighted sum of difference by an amount, which is indicated as a number of pixels on the first frame or the second frame, for generating the motion proportion;
wherein the plurality of weights for sum of pixel differences are corresponding to different values of the sums of pixel difference.

21. The display system of claim 14,
wherein the block segmenting module transforms a plurality of pixel values of the plurality of pixels of the plurality of first and second bocks into a plurality of luminance values;
wherein the sum of difference calculating module calculates a sum of luminance differences between the pair of first and second blocks;
wherein the motion proportion calculating module calculates the motion proportion according to all sums of luminance differences between the first frame and the second frame and according to a plurality of weights for sum of luminance differences.

22. The display system of claim 21,
wherein the sum of difference calculating module calculates the sum of luminance differences according to the following equation:
$$FA\_SOD ( m , n ) = {\sum }_{m = 1}^{M} {\sum }_{n = 1}^{N} \vert FA\_P ( m , n ) - FB\_P ( m , n ) \vert ;$$
wherein each of the first and second blocks respectively comprises a same amount of pixels, which are arranged as a matrix; each pixel of the first block has a corresponding pixel within the second block to form a pair; and M and N respectively indicate a length and a width of the matrix;
wherein FA_SOD(m,n) indicates the sum of luminance differences, (m,n) indicates a coordinate occupied by both a first reference pixel on the first block and a second reference pixel on the second block, FA_P(m,n) indicates a representative luminance value on the first block, and FB_P(m,n) indicates a representative luminance value on the second block.

23. The display system of claim 22,
wherein the sum of difference calculating module fetches a plurality of most significant bits from the sum of luminance differences so as to generate a normalized sum of luminance differences.

24. The display system of claim 21,
wherein the motion proportion calculating module multiplies each of the sums of luminance difference between the first and second frames with one of the plurality of weights for sum of luminance differences according to different values of the sums of luminance difference between the first and second frames, for generating a plurality of weighted sums of luminance difference;
wherein the motion proportion calculating module sums the generated plurality of weighted sums of luminance difference to generate a total weighted sum of difference, and dividing the total weighted sum of difference by an amount, which is indicated as a number of pixels on the first frame or the second frame, for generating the motion proportion;
wherein the plurality of weights for sum of luminance differences are corresponding to different values of the sums of luminance difference.

25. The display system of claim 14,
wherein the frame modulation module establishes a lookup table, which stores both a frame rate corresponding to the motion proportion and a display state of whether the frame is displayed under the frame rate;
wherein the frame modulation module queries the lookup table by using the motion proportion as an index, for determining the frame rate and whether the frame is displayed under the determined frame rate.

26. The display system of claim 14, further comprising:
an over-driving circuit, for performing over-driving on the first frame and the second frame for generating an over-driven frame;
wherein the frame modulation module determines a frame rate for displaying the over-driven frame and whether the over-driven frame is displayed, according to the motion proportion.
